(19) United States
(12) Patent Application Publication
(10) Pub. No.: US 2020/0182190 A1
(43) Pub. Date: Jun. 11, 2020

(54) PISTON COMBUSTION CHAMBER STRUCTURE OF ENGINE

(71) Applicants: HYUNDAI MOTOR COMPANY, Seoul (KR); KIA MOTORS CORPORATION, Seoul (KR)

(72) Inventors: Sung Oh RA, Seongnam-si (KR); Kyung Beom KIM, Suwon-si (KR); Dong-Hyun CHO, Incheon (KR); Young Hoon SONG, Suwon-si (KR); Joon Kyu LEE, Yongin-si (KR); Hyuckmo KWON, Yongin-si (KR)

(21) Appl. No.: 16/433,734

(22) Filed: Jun. 6, 2019

(30) Foreign Application Priority Data
Dec. 7, 2018 (KR) 10-2018-0157498

(51) Int. Cl. F02F 3/26; F02B 23/06

(52) U.S. Cl. CPC F02F 3/26; F02B 23/0621

(57) ABSTRACT

A piston combustion chamber structure of an engine includes two or more independent combustion chambers separated from each other and dented on an upper portion of a piston head in axial and circumferential directions. Each of the two or more independent combustion chambers comprises an outer wall and a bottom surface. Independent combustion chambers adjacent to each other among the two or more independent combustion chambers are partitioned by a partition wall. The partition wall has a slant surface such that a squish flowing in the circumferential direction can be generated.

### CROSS-REFERENCE TO RELATED APPLICATION

This application claims priority to and the benefit of Korean Patent Application No. 10-2018-0157498 filed in the Korean Intellectual Property Office on Dec. 7, 2018, the entire contents of which are incorporated herein by reference.

### TECHNICAL FIELD

The present disclosure relates to a combustion chamber of an engine. More particularly, the present disclosure relates to a piston combustion chamber structure of an engine in which independent combustion chambers are formed in a piston head in a circumferential direction.

### BACKGROUND

Generally, a gasoline engine used in a vehicle ignites a mixture of air and fuel mixed uniformly with a spark plug to be combusted, while a diesel engine sucks air only and compresses it with a high compress ratio to be combusted by a self-ignition system.

In the diesel engine, improvement of combustion is the most important in order for the reduction of harmful exhaust gas and the enhancement of fuel efficiency, and the combustion chamber formed in the piston head is configured to provide a turbulent flow (swirl, vortex or tumble, etc.) of the intake air to improve the mixing of air and fuel and having a shape that can promote fuel atomization.

The fuel atomization improves the mixing performance with the ambient air and fuel by increasing the surface area of the droplets by making the fuel injected from the injector into droplet cloud of a number of small droplets.

The atomization promotion can be promoted by physical shape of the injector nozzle or interaction with the colliding ambient air during the injection process or collision with the wall surface of the combustion chamber, and the combustion chamber structure of the diesel engine is designed to further improve this phenomenon.

Typically, a multi-injection system has been employed in the diesel engine in which at least two rows of fuel line are simultaneously injected into a combustion chamber. After the fuel injected into in the combustion chamber through the multi-injection system collides with the outer wall surface of the fuel chamber, superimposition may occur by the air flow inside the combustion chamber between the adjacent fuel lines in the process of being reflected back into the combustion chamber, and the superimposition between these reflected fuel lines increases the risk of incomplete combustion, resulting in reduced fuel efficiency and emission of harmful emissions.

Therefore, the present disclosure focus on preventing incomplete combustion caused by reflection superimposition of fuel by improving the structure of the combustion chamber formed in the piston head in a diesel engine that adopts a multi-injection system using a plurality of fuel lines.

The above information disclosed in this Background section is only for enhancement of understanding of the background of the disclosure and therefore it may contain information that does not form the prior art that is already known in this country to a person of ordinary skill in the art.

### SUMMARY

The present disclosure has been made in an effort to provide a piston combustion chamber structure of an engine which forms a plurality of independent combustion chambers independent from each other in a circumferential direction on a piston head in a diesel engine that adopts a multi-injection system injecting a plurality of fuel lines, thereby preventing superimposition phenomenon in which the reflected adjacent fuel lines are mixed by a flow of air inside a combustion chamber and thus incomplete combustion during the fuel is injected into the combustion chamber wall and then reflected. Further, each independent combustion chamber forms a curved wall and sloped passageway to prevent wall wetting, and a slanted surface is formed at a partition wall separating each independent combustion chamber in order that a squish may occur in a circumferential direction, thereby smoothly supplying outside air to the periphery of the injected fuel where combustion occurs to improve combustion efficiency.

A piston combustion chamber structure of an engine according to an exemplary embodiment of the present disclosure may include two or more independent combustion chambers separated from each other and dented on an upper portion of a piston head in axial and circumferential directions. Each of the two or more independent combustion chambers may comprise an outer wall and a bottom surface. Independent combustion chambers adjacent to each other among the two or more independent combustion chambers are partitioned by a partition wall. The partition wall may have a slant surface in order that a squish flowing in the circumferential direction can be generated.

The outer wall and the bottom surface may be formed of a curved surface.

The curved surface may have a cross section of a circular arc shape or an elliptical shape.

A pip portion in the center of the bottom surface of each independent combustion chamber may protrude in a height direction of the piston head.

The height of the bottom surface may gradually decrease from the pip portion toward an outside in a radial direction.

The height of the partition wall may be lower than an upper surface of the piston head.

The maximum depth from an upper surface of the piston head to the bottom surface may be greater than the maximum depth from the upper surface of the piston head to the partition wall and less than three times the maximum depth from the upper surface of the piston head to the partition wall.

The maximum width of the independent combustion chamber may be less than ½ of a gap between the partition walls.

The width of the bottom surface may be equal to or less than ⅓ of a gap between the partition walls.

The exterior diameter of the independent combustion chamber may be larger than the exterior diameter of the partition wall and smaller than 1.5 times the exterior diameter of the partition wall.

The expansion width of the independent combustion chamber extending radially outward from an end portion of the partition wall may be equal to or less than ⅓ of a gap between the partition walls.

The partition wall may be formed of a spiral shape.

In accordance with the piston combustion chamber structure of the engine according to an exemplary embodiment of the present disclosure, a plurality of independent combustion chambers extended in the radial direction and independent from each other in the circumferential direction are formed on the piston head in the diesel engine that adopts a multi-injection system injecting a plurality of fuel lines, so that it is possible to prevent the superimposition phenomenon that the reflected fuel lines adjacent to each other are mixed due to air flow inside the combustion chamber and thus incomplete combustion during fuel is injected to the wall of the combustion chamber and then reflected from the wall.

Further, each independent combustion chamber forms the curved wall and sloped passageway to effectively prevent wall wetting, and the slanted surface is formed at a partition wall separating each independent combustion chamber so that a squish may occur, thereby smoothly supplying outside air to the periphery of the injected fuel where combustion occurs to improve combustion efficiency.

### BRIEF DESCRIPTION OF THE DRAWINGS

FIG. 1 is a perspective view of a piston combustion chamber structure of an engine according to an exemplary embodiment of the present disclosure;

FIG. 2 is a top plan view of the piston combustion chamber structure of the engine according to the exemplary embodiment of the present disclosure;

FIG. 3 is a cross-sectional view taken along A-A line of FIG. 2;

FIG. 4 is a cross-sectional view taken along B-B line of FIG. 2;

FIG. 5 is a perspective view showing a process of injecting fuel into the piston combustion chamber structure of the engine according to the exemplary embodiment of the present disclosure; and

FIG. 6 is a perspective view of a piston combustion chamber structure of an engine according to another exemplary embodiment of the present disclosure.

### DETAILED DESCRIPTION OF THE EMBODIMENTS

Hereinafter, exemplary embodiments of the present disclosure will be described in detail with reference to accompanying drawings.

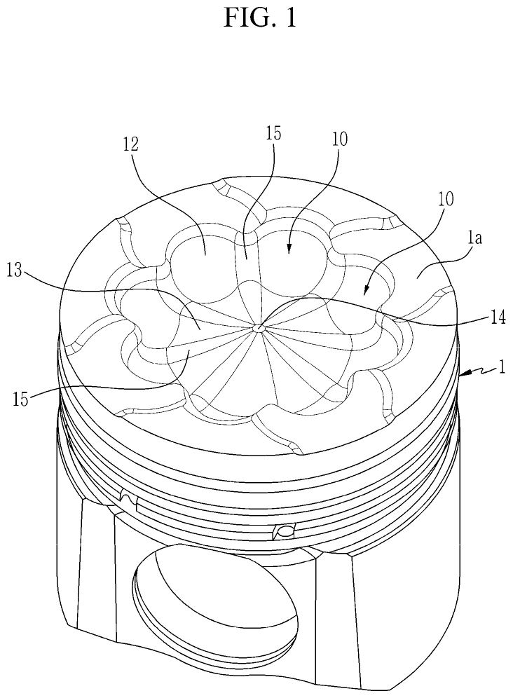

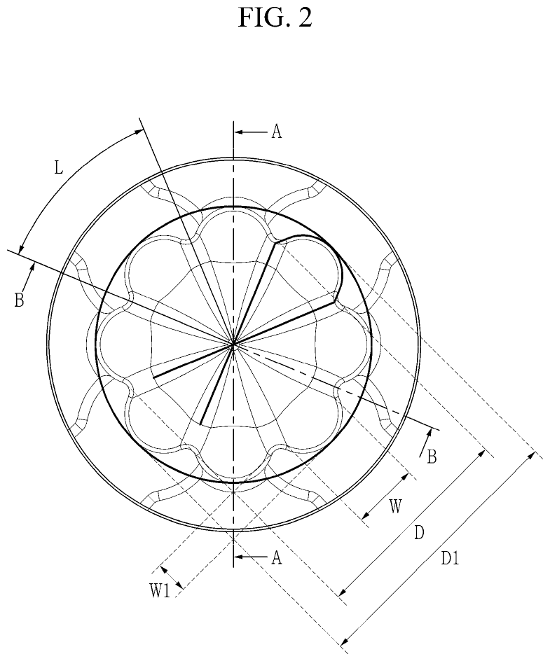

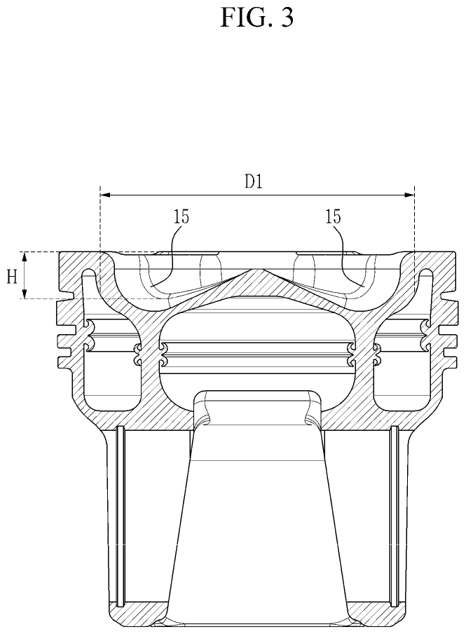

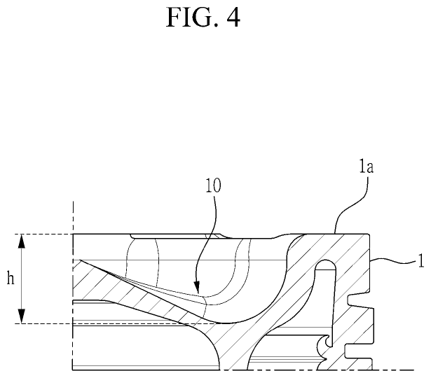

Referring to FIGS. 1 to 4, a piston combustion chamber structure of an engine according to an exemplary embodiment of the present disclosure may include a plurality of independent combustion chambers 10 dented in an axial direction and a circumferential direction on an upper portion of a piston head 1 reciprocating vertically.

Each independent combustion chamber 10 may include a curved outer wall 12 forming an outer wall of the combustion chamber and a substantially funnel-shaped bottom surface 13 forming the bottom of the combustion chamber 10, respectively, and an upper portion of each independent combustion chamber 10 is configured to be opened.

The curved outer wall 12 may have a circular arc shape or a cross-section of an elliptical shape. The bottom surface 13 may be a curved surface of a circular arc shape or an elliptical shape.

A cylinder head (not shown) is fastened to a cylinder block (not shown) above the piston head 1 so that the upper portion of each independent combustion chamber 10 can be closed and sealed by the cylinder head.

Further, the cylinder head may be equipped with an intake port for flowing outside air into the independent combustion chamber 10 and an exhaust port for exhausting the exhaust gas combusted in the combustion chamber.

The beginning portion (the center of fuel injection) of the bottom surfaces 13 of each independent combustion chamber 10, that is, a pip portion 14 is formed in a shape having a predetermined height by protruding in the height direction of the piston head 1. The pip portion 14 may have a shape gradually decreasing in height from the bottom surface 13 of the independent combustion chamber 10 toward the outer radial direction.

That is, the height of the bottom surface 13 of each independent combustion chamber 10 is the highest at the pip portion 14 and gradually decreases toward the outer wall 12 so that the portion adjacent to the outer wall 12 is the lowest.

A partition wall 15 may protrude in the direction of an upper surface 1a of the piston head 1 in order to separate each independent combustion chamber 10.

The height of the partition 15 may be lower than the upper surface 1a of the piston head 1.

Further, the partition 15 may have a slant surface so that a squish flowing in a circumferential direction can be generated. The term “squish” can be understood by one of ordinary skill in the art as an effect in internal combustion engines which creates sudden turbulence of the fuel/air mixture as the piston approaches top dead centre (TDC).

Each independent combustion chamber 10 can be separated along the circumferential direction with the partition 15 therebetween.

In the exemplary embodiment of the present disclosure, although each independent combustion chamber 10 is shown as six, it is only one exemplary embodiment corresponding to the number of fuel injection holes of the injector, and may be formed by two or more numbers.

The maximum depth h of the bottom surface 13 from the top surface of the piston head 1 may be greater than the maximum depth H of the partition wall 15 from the top surface of the piston head 1 and less than three times the maximum depth H of the partition wall 15.

That is, the maximum depth h of the bottom surface 13 may be H<h<3H in consideration of the durability of the piston.

Further, the maximum width W of the independent combustion chamber 10 may be less than ½ of the gap L between the partition walls 15 in consideration of the injection angle of the injector nozzle (W<0.5L).

Further, the width of the bottom surface 13 may be equal to or less than ⅓ of the gap L between the partition walls 15.

An exterior diameter D1 of the independent combustion chamber 10 may be larger than an exterior diameter D of the partition wall 15 and less than 1.5 times of the exterior diameter D of the partition wall 15 in order to minimize the heat loss of the combustion gas (D<D1<1.5D).

Additionally, the expansion width W1 of the independent combustion chamber 10 extending radially outward from the end portion of the partition wall 15 may be less than ⅓ of the gap L between the partition walls 15 and the extension width W1 may be determined in consideration of the fuel injection angle of the injector and heat transfer minimization simultaneously.

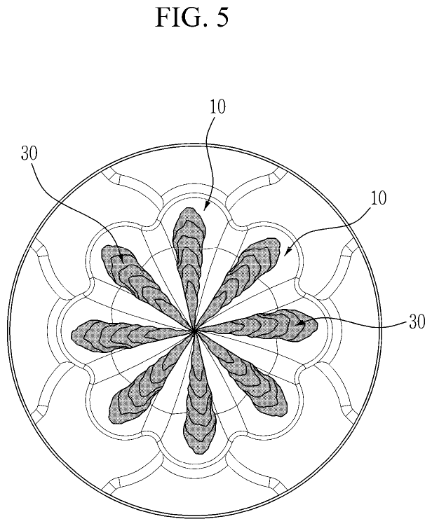

In accordance with the combustion chamber structure according to an exemplary embodiment of the present disclosure as described above, as shown in FIG. 5, fuel 30 is injected from the injector into the combustion chamber space formed in each independent combustion chamber 10, and the injected fuel is mixed with air only in each independent combustion chamber 10 and combusted. Fuel 30 injected into each independent combustion chamber 10 is blocked by the partition wall 15 and is not likely to be mixed with each other, so that the combust efficiency can be improved and the incomplete combustion can be prevented.

As a result, it is possible to eliminate the incomplete combustion caused by the superimposition of the fuel that is reflected after the conventional fuel injection, and to improve the enhancement of fuel efficiency and reduce harmful exhaust gas.

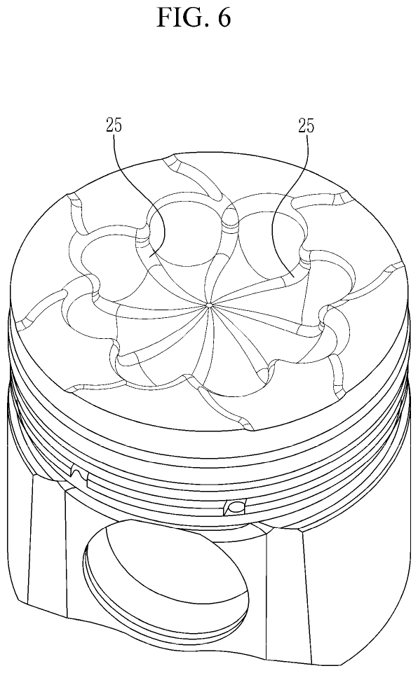

On the other hand, referring to FIG. 6, when the air flowing into each independent combustion chamber through the intake port of the cylinder head is subjected to a strong swirl flow, partition walls 25 may be formed in a spiral shape.

While this disclosure has been described in connection with what is presently considered to be practical exemplary embodiments, it is to be understood that the disclosure is not limited to the disclosed embodiments. On the contrary, it is intended to cover various modifications and equivalent arrangements included within the spirit and scope of the appended claims.

What is claimed is:

1. A piston combustion chamber structure of an engine, comprising:
two or more independent combustion chambers separated from each other and dented on an upper portion of a piston head in axial and circumferential directions,
wherein each of the two or more independent combustion chambers comprises an outer wall and a bottom surface,
wherein independent combustion chambers adjacent to each other among the two or more independent combustion chambers are partitioned by a partition wall, and
wherein the partition wall has a slant surface such that a squish flowing in the circumferential direction can be generated.

2. The piston combustion chamber structure of claim 1, wherein each of the outer wall and the bottom surface has a curved surface.

3. The piston combustion chamber structure of claim 2, wherein the curved surface has a cross section of a circular arc shape or an elliptical shape.

4. The piston combustion chamber structure of claim 1, wherein a pip portion in a center of the bottom surface protrudes in a height direction of the piston head.

5. The piston combustion chamber structure of claim 4, wherein a height of the bottom surface gradually decreases from the pip portion toward an outside in a radial direction.

6. The piston combustion chamber structure of claim 1, wherein a height of the partition wall is lower than an upper surface of the piston head.

7. The piston combustion chamber structure of claim 1, wherein a maximum depth from an upper surface of the piston head to the bottom surface is greater than and less than three times a maximum depth from the upper surface of the piston head to the partition wall.

8. The piston combustion chamber structure of claim 1, wherein the partition wall is provided in plural, and
wherein a maximum width of each of the two or more independent combustion chambers is less than ½ of a gap between the partition walls.

9. The piston combustion chamber structure of claim 1, wherein the partition wall is provided in plural, and
wherein a width of the bottom surface is equal to or less than ⅓ of a gap between the partition walls.

10. The piston combustion chamber structure of claim 1, wherein an exterior diameter of each of the two or more independent combustion chambers is larger than and smaller than 1.5 times an exterior diameter of the partition wall.

11. The piston combustion chamber structure of claim 1, wherein the partition wall is provided in plural, and
wherein an expansion width of each of the two or more independent combustion chambers extending radially outward from an end portion of the partition wall is equal to or less than ⅓ of a gap between the partition walls.

12. The piston combustion chamber structure of claim 1, wherein the partition wall has a spiral shape.
